(19) United States
(12) Patent Application Publication
(10) Pub. No.: US 2004/0162895 A1
(43) Pub. Date: Aug. 19, 2004

(54) Web site management with electronic storefront and page categorization

(75) Inventors: Tuck Thin Mok, Whitestone, NY (US); Halldor Gunnarsson, Yven (NO); Vidar Petursson, Reykjavik (IS)

Correspondence Address: KENYON & KENYON, 1500 K STREET, N.W., SUITE 700, WASHINGTON, DC, 20005, US

(73) Assignee: B2B BOOSTER, INC., College Point, NY

(21) Appl. No.: 10/367,936

(22) Filed: Feb. 19, 2003

(51) Int. Cl. G06F 15/173

(52) U.S. Cl. 709/223

(57) ABSTRACT

A system and method of managing web sites provides for establishing a web site account corresponding to a domain name. A setup function is applied to content associated with the web site account based on page categorization input from a web browser. By using page categorization input, a number of aspects of web site creation can be automated.

### BACKGROUND

1. Technical Field

Embodiments of the present invention generally relate to the management of web sites. More particularly, embodiments relate to the use of page categorization input to create and maintain web sites that include electronic storefronts.

2. Discussion

As the Internet continues to grow in popularity, E-Commerce web sites, or web sites having the ability to function as electronic storefronts, are becoming more and more prevalent in the marketplace. Indeed, online shopping has begun to rival traditional point-of-sale shopping in recent years. Although consumers, or web site “visitors”, have come to expect the ability to shop for and purchase merchandise over the Internet, a number of difficulties have evolved from the perspective of the merchant, or “user”, of the web site.

For example, in order to manage a web site, individual web pages as well as the necessary hyperlinks, or “links”, between web pages must be created. Typical web sites operating as electronic storefronts have web pages dedicated to site content as well as the underlying product data that represents the merchandise to be purchased. For example, site content may include a home page, or “front page”, that provides links to pages having information about the company and recent press releases. Product data is used to create pages specifically describing the merchandise (or services) to be purchased. Although early approaches to creating web pages required knowledge of the hypertext transfer protocol (HTTP), it was not long before tools were developed to provide a more user-friendly interface. Indeed, most commercial word processing programs include mechanisms for converting documents into web pages. Unfortunately, these products still require a significant amount of input from the user in order to format the various types of site content/product data. For example, the user must still design the layout of each page, as well as insert the necessary links. As a result, it is not uncommon for businesses to hire web site designers to create web sites as well as the underlying electronic storefronts. Unfortunately, the cost of such services is often prohibitive to smaller businesses.

In an effort to address the above concerns, a number of web site hosting services such as Yahoo® Store and Homestead™ have been developed. While such services provide the user with the ability to use templates to create web pages for site content and product data, a number of difficulties remain. In particular, conventional services still require the user to format each page and provide little guidance in the page setup process. As a result, it is not uncommon for the user to have to develop formats for many different types of site content such as front pages, news pages, drop down linking pages (e.g., top level pages that have visible links to lower level pages), servicing and support pages, employment (or work) application forms, and feedback forms. In addition, the links between pages typically must be created and inserted into pages on a link-by-link basis, regardless of whether a template is used. As a result, conventional approaches to creating web sites are often cumbersome and time-consuming.

Furthermore, maintaining the electronic storefront portion of web sites typically requires the user to view and access product data from the “back end” of the system. Although many conventional services provide robust product searching capabilities to visitors of a given storefront, the same is not true with regard to users tasked with maintaining the storefront. Indeed, it is not uncommon for the process of locating a particular product from the back end of the system to involve navigating through the correct series of links to the given product. There is therefore a need for a system and method of managing web sites and electronic storefronts that minimizes the need for manual formatting and provides a back end interface that is less cumbersome to use than traditional approaches.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a web site management system according to one embodiment of the invention;

FIG. 2 is a block diagram of an example of an electronic shopping manager according to one embodiment of the invention;

FIG. 3 is a block diagram of an example of a multi-domain web site management system according to one embodiment of the invention;

FIG. 4 is a block diagram of an example of a web site management system having a plurality of setup functions according to one embodiment of the invention;

FIG. 5A is a block diagram of an example of a feedback form setup function, a work application form setup function, and an inquiry manager according to one embodiment of the invention;

FIG. 5B is a block diagram of an example of a news setup function according to one embodiment of the invention;

FIG. 5C is a block diagram of an example of a password protection setup function according to one embodiment of the invention;

FIG. 6 is a block diagram of an example of a product categorization scheme according to one embodiment of the invention;

FIG. 7 is a block diagram of an example of a language management scheme according to one embodiment of the invention;

FIG. 8 is a flowchart of an example of a method of managing a web site according to one embodiment of the invention;

FIG. 9 is a flowchart of an example of a process of applying setup functions to content based on page categorization input according to one embodiment of the invention;

FIG. 10 is a screen shot of an example of a page categorization interface according to one embodiment of the invention;

FIG. 11 is a screen shot of an example of having the ability to operate as an electronic storefront according to one embodiment of the invention;

FIG. 12 is a screen shot of an example of a page manager according to one embodiment of the invention;

FIG. 13 is a screen shot of an example of a page editor according to one embodiment of the invention;

FIG. 14 is a screen shot of an example of a web site front page resulting from use of the page editor shown in FIG. 13 according to one embodiment of the invention;

FIG. 15 is a screen shot of an example of a visitor access manager according to one embodiment of the invention;

FIG. 16 is a screen shot of an example of a visitor authentication interface according to one embodiment of the invention;

FIG. 17 is a screen shot of an example of a web site news page according to one embodiment of the invention;

FIG. 18 is a screen shot of an example of a modified web site news page according to one embodiment of the invention;

FIG. 19 is a screen shot of an example of a product manager according to one embodiment of the invention;

FIG. 20 is a screen shot of an example of a product editor according to one embodiment of the invention; and

FIG. 21 is a screen shot of an example of a language manager according to one embodiment of the invention.

### DETAILED DESCRIPTION

Embodiments of the present invention make use of page categorization input to facilitate the setup and maintenance of web pages in a web site and an underlying electronic storefront. For example, it has been determined that the behavior and appearance of certain types of web pages can be pre-defined so that certain aspects of the page setup process are automated. For example, the user is given the ability to create a “frontpage” category, where pages assigned to this category can be automatically defined as an index page of the corresponding web site account. The user may also create a “news” category, where pages assigned to this category are automatically formatted as a function of headline creation time. Other types of categories such as “drop down link,” “service and support,” “work applications” and “feedback form” further facilitate the management of web sites and electronic storefronts. Thus, the creation of web pages can be less cumbersome and less time consuming.

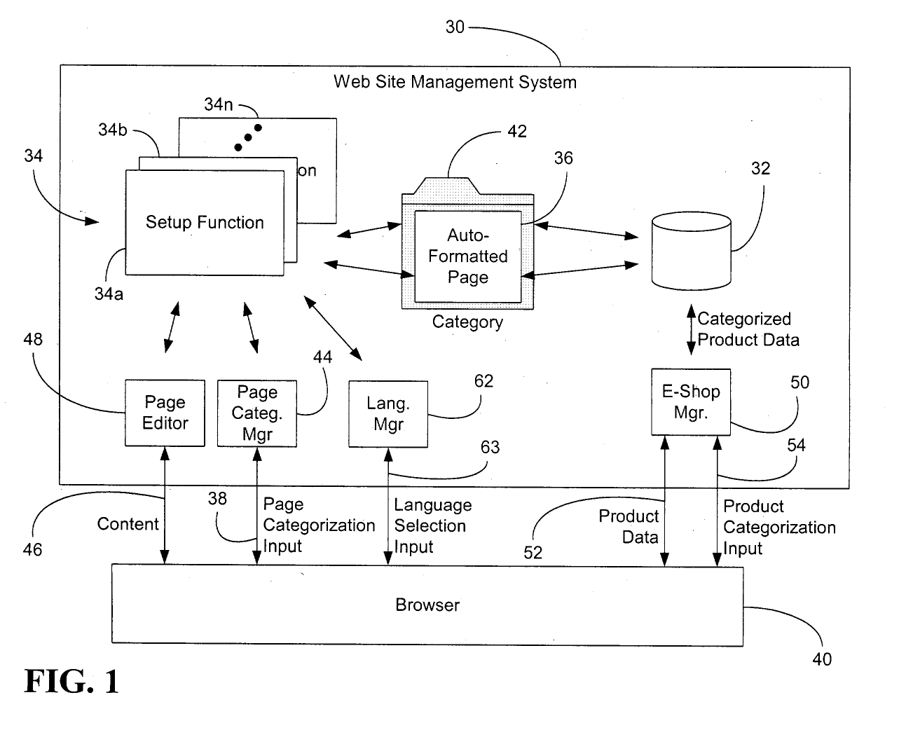

Turning now to FIG. 1, a web site management (or “content management”) system 30 is shown according to one embodiment of the invention. Management system 30 has a database 32 configured to store web pages such as web page 36, which is associated with a web site account and domain name. One or more setup functions 34 (34a-n) automatically format each web page 36 based on page categorization input 38 from a web browser 40 running on a client machine. The management system 30 and browser 40 communicate over an acceptable network such as the Internet. Each setup function 34 has a corresponding page category, where each page category provides a type of folder for storing web pages. Thus, web page 36 is formatted based on the category associated with folder 42, where folder 42 is defined by the page categorization input 38.

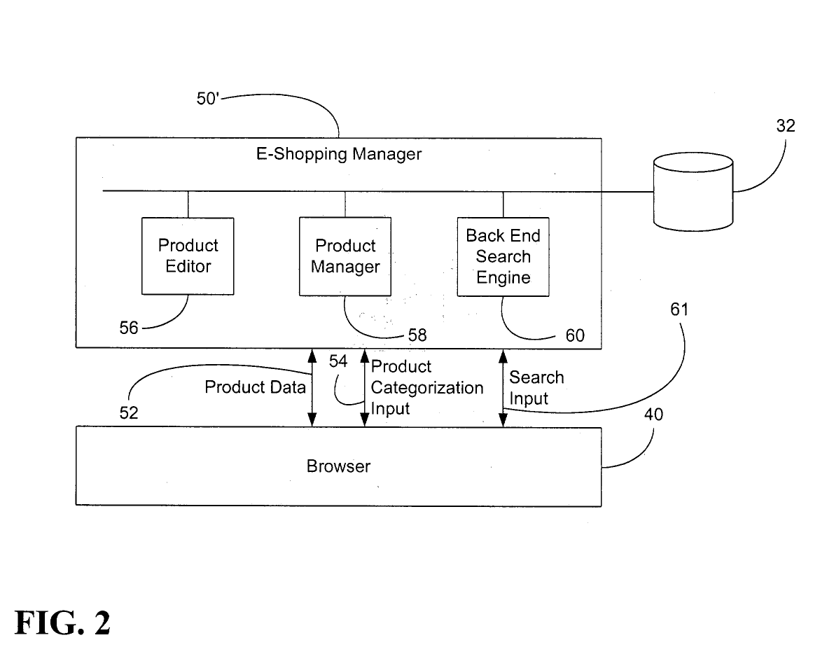

The account holder may also desire for the web site to operate as an electronic storefront. In such a case, web site management system 30 also includes an electronic shopping (e-shopping) manager 50 to organize product data 52 in the database 32 based on one or more product categories defined by product categorization input 54. FIG. 2 shows one approach to an e-shopping manager 50′ in greater detail. Specifically, the illustrated e-shopping manager 50′, has a product editor 56 that enables the user to enter and selectively associate the product data 52 with one or more of the product categories. A product manager 58 may also be used to organize the product data 52 into the product categories. The e-shopping manager 50′ may also include a back end search engine 60 that enables the user to provide search input 61 and search the product data 52. Back end searching significantly enhances the users' ability to maintain the electronic storefront.

Site Content Management

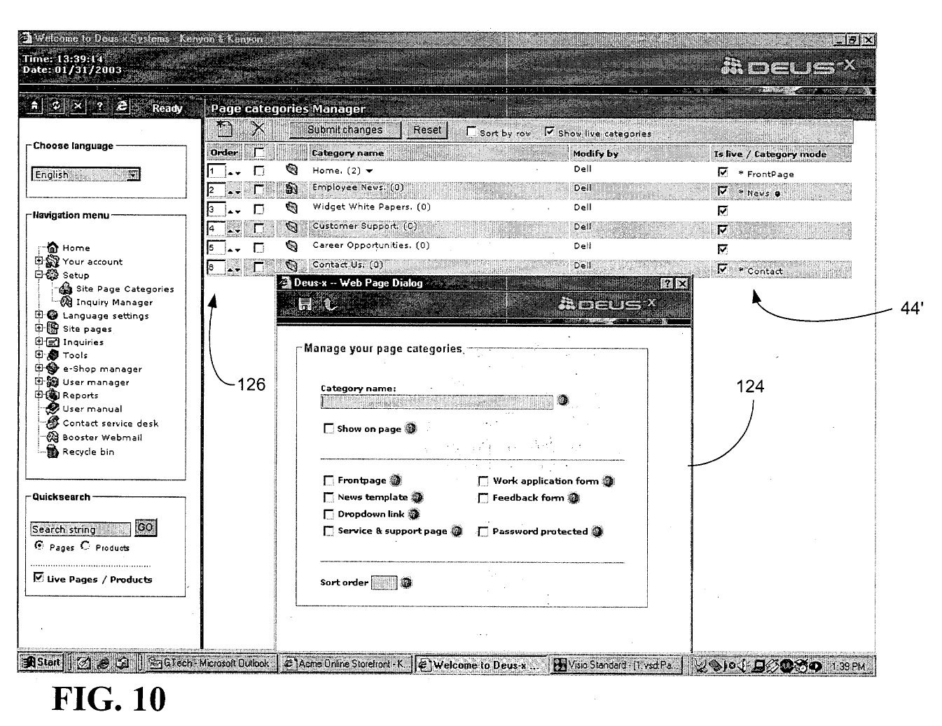

With continuing reference to FIGS. 1 and 10-14, it can be seen that a page categories manager 44 facilitates selection of the appropriate setup function 34 based on the page categorization input 38. In addition, the page categories manager 44′ enables the user to view the folders created in response to the page categorization input 38. FIG. 10 illustrates one approach to a page categories manager at 44′ in which the page categorization input is obtained via categorization interface 124. Thus, the user can simply place a “check” in the box adjacent to the category of choice. All of the folders that have been created are listed in an order that can be rearranged by changing the assigned rankings in order column 126. A page editor 48 enables the user to input content 46 to the web site management system 30. The content 46 can be inserted by traditional word processing techniques, hypertext transfer protocol (HTTP) programming, or “browsing” actions, and may include images of any standard format such as joint photographic experts group (JPEG), graphics interchange format (GIF), bit map (BMP), etc.

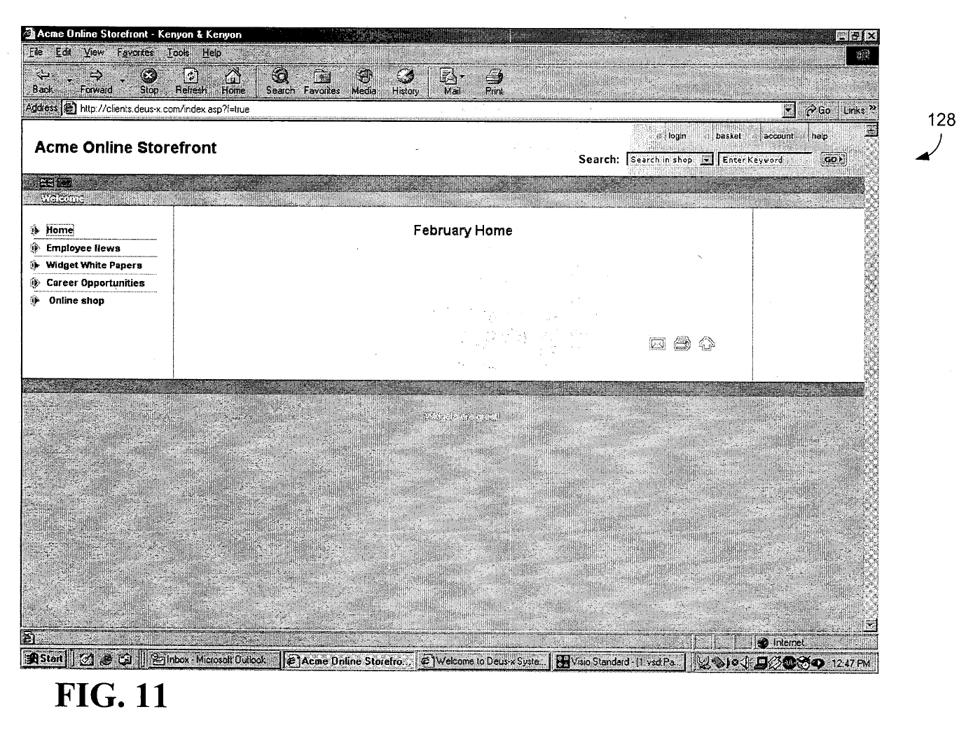

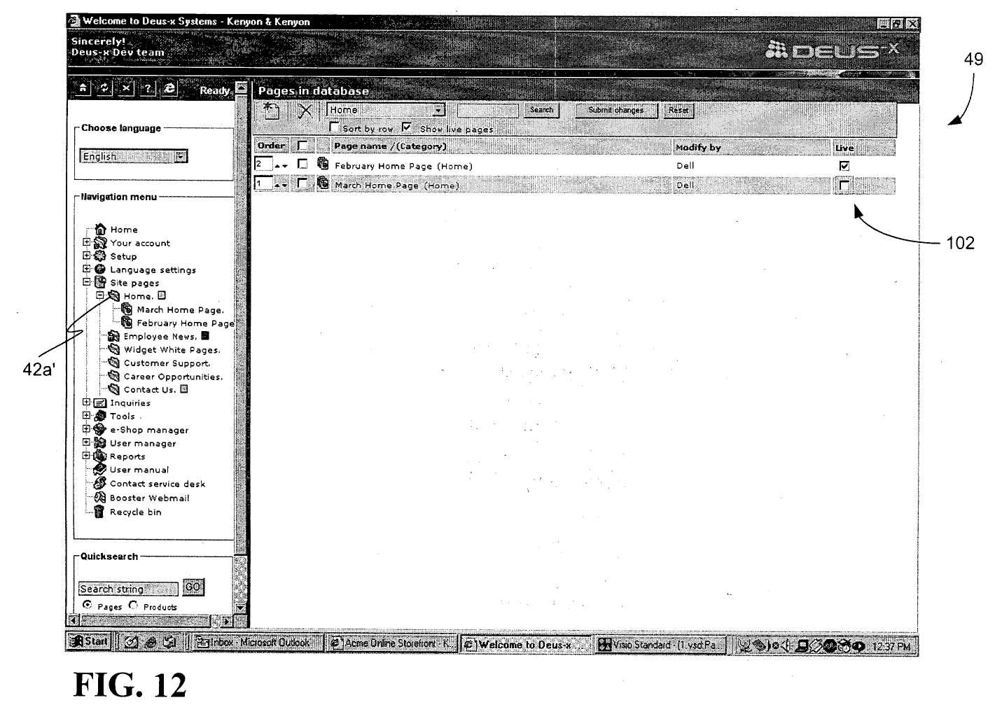

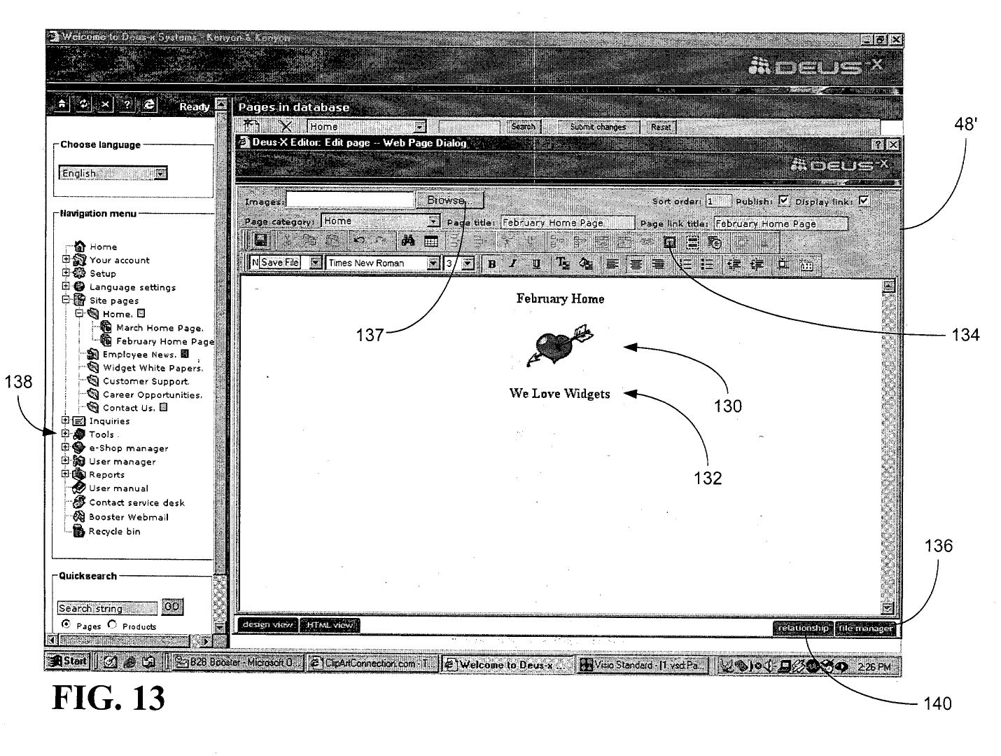

FIG. 11 shows a home page 128 of a web site having an electronic storefront, relatively early in the web site creation process. FIG. 12 illustrates a page manager 49, which enables the user to view all of the pages assigned to a particular category. Specifically, two web pages entitled “February Home Page” and “March Home Page” have been added to a front page folder 42a′ entitled “Home”. Page manager 49 uses a “live” column 102 to obtain the page status input. In the illustrated example, the front page entitled “February Home Page” has been selected by the user as being live. If both (or neither) of the web pages are designated as being live, the system can default to the first one created. FIG. 13 shows one approach to a page editor 48′ in which content including an image 130 and additional text 132 is to be added to the home page 128 (FIG. 11).

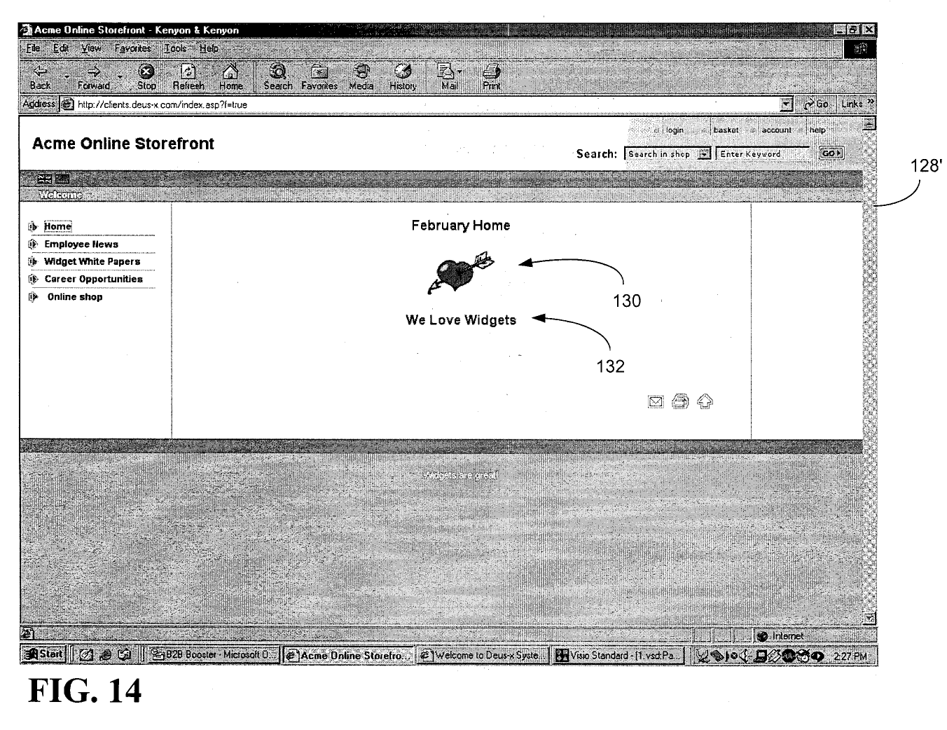

The image 130 can be inserted in a number of different ways. For example, by selecting a “Browse . . . ” button 137, the user can browse a local drive or a network drive of a computer, and enter the appropriate path to the desired image. In another approach, by selecting an image properties button 134, the user is able to enter a universal resource locator (URL). Alternatively, the user can select the “file manager” button 136, which results in a dialog that displays, the images that have been uploaded to the web site management system for selection. In this regard, a tools option 138 provides for the uploading of files. Images that have been uploaded can be dragged and dropped directly into the page editor 48′. The dialog for dragging and dropping images into the page editor 48′ also has a popup window check box for generating a popup window of the selected image. If the user places a check in the popup window check box, a window with a full size version of image will automatically appear whenever visitors click on the small version of the image contained on the web page. It should also be noted that the page editor 48′ has a “relationship” button 140, which permits the user to define the page in question as a subpage of another page. Thus, multi-level hierarchies can be readily created. In any event, FIG. 14 illustrates a revised home page 128′ that includes the image 130 and additional text 132′.

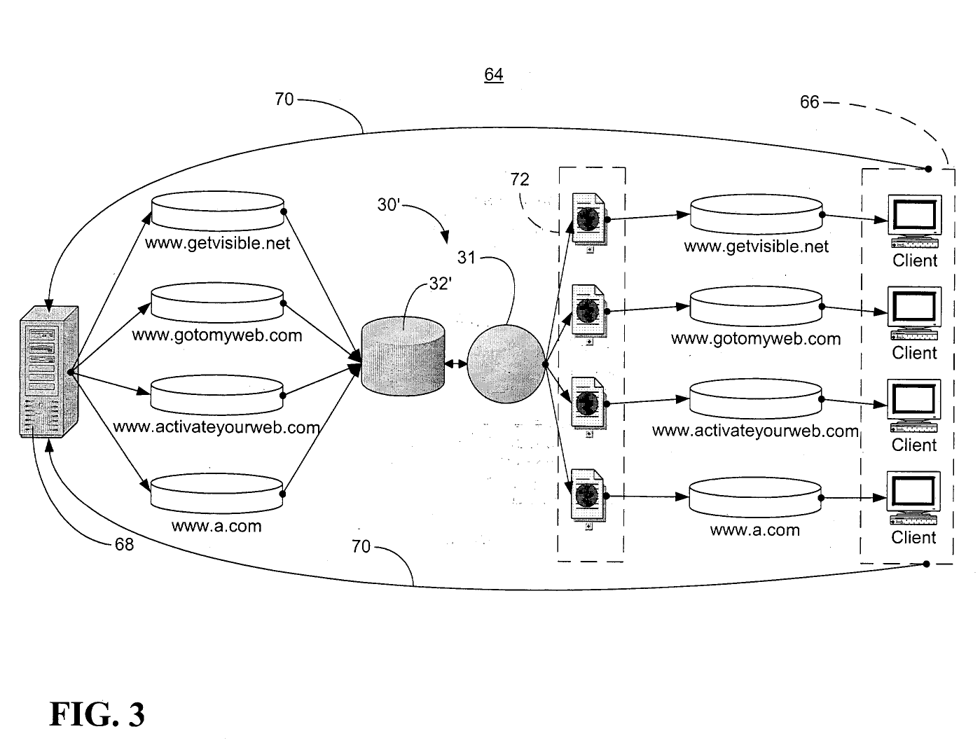

Turning now to FIG. 3, architecture 64 illustrates that the web site management system 30′ host web site accounts for a plurality of domain names corresponding to a plurality of account holders (not shown). Web site visitors operating client computers 66 can submit domain name requests 70 (by typing the appropriate URL, selecting a link, etc.). The web server 68 receives the client domain name requests 70 and the web site management system 30′ uses script 31 to display web site pages corresponding to the selected domain names. Each domain name has a dedicated portion of the database 32′, and has been set up using templates 72.

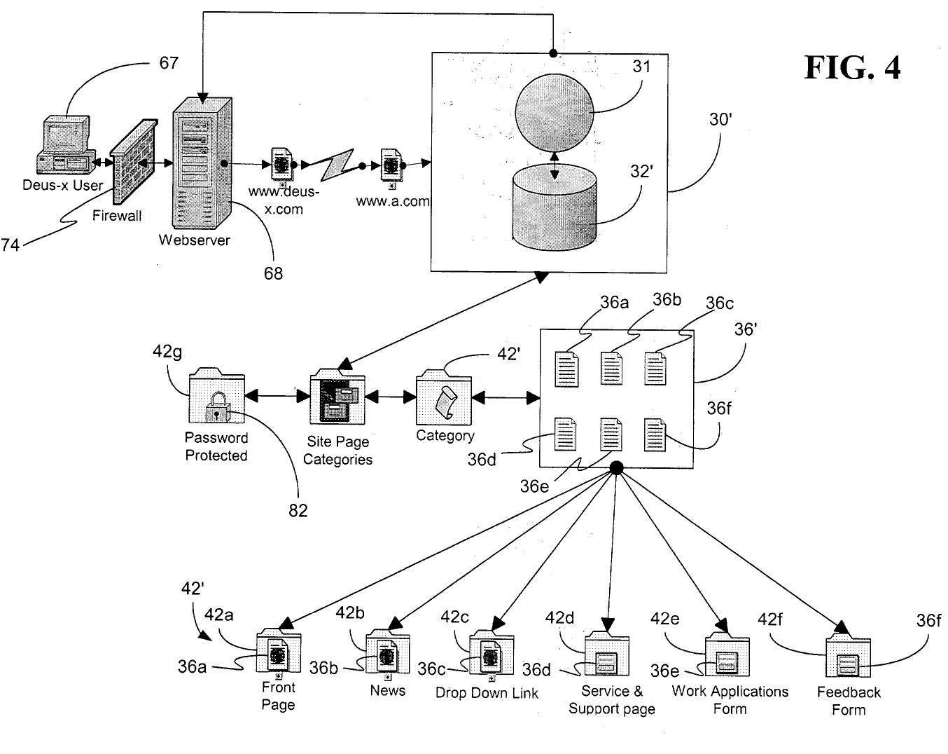

FIG. 4 shows an example of the web site management system 30′ in which user 67 accesses web server 68 through a firewall 74 in order to log in to the site associated with web site management system 30′ (e.g., “www.deus-x.com”). The user 67, operating a computer having any appropriate web browser 40 (FIG. 1), may then access the portion of the database 32′ dedicated to the web site account associated with user 67 (e.g., “www.a.com”). The user 67 provides page categorization input by selecting a category from a plurality of site page categories.

For example, the user may create a folder 42′ by selecting a category from the plurality of site page categories, where folder 42′ may be of any of the types of folders 42a-42g. Thus, the setup function corresponding to the selected category will be applied to the desired content, where the resulting web page 36′ (36a-36f) is stored in the created folder. For example, the user might select the front page category for folder 42′. In such a case, a web page 36a is created by applying the front page setup function to the content in question. Web page 36a is then stored in the appropriate folder 42a, which corresponds to the front page setup function and category. It can also be seen that an additional password protection folder 42g can be created if restricted access to the resulting web page is desired, where the password protection folder 42g stores visitor and user privileges 82.

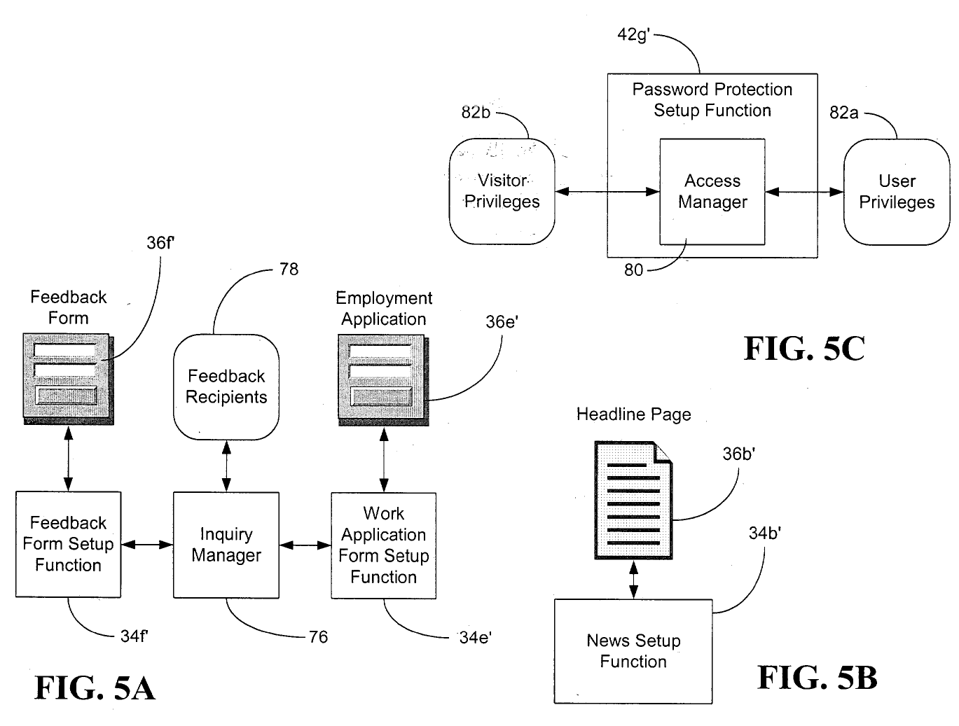

FIGS. 5A-5C illustrate the use of setup functions to facilitate the page creation process in greater detail. For example, FIG. 5A shows a feedback form setup function 34f′ capable of creating a feedback form 36f′, a work application form setup function 34e′ capable of creating employment application 36e′, and an inquiry manager 76, which enables the user to setup feedback recipients 78 and view submitted inquiries. The inquiry manager 76 also enables the user to view resumes submitted via employment application 36e′. Thus, in the case of the employment application 36e′, the page categorization input causes the work application form setup function 34e′ to create a folder that is dedicated to employment applications. Upon receiving content such as a description of a particular job via the page editor 48 (FIG. 1), the work application form setup function 34e′ automatically formats the content as employment application 36e′ to enable a visitor to apply for employment and to submit a resume. Similarly, in the case of feedback form 36f′, the page categorization input causes the feedback form setup function 34f′ to create a folder that is dedicated to feedback forms. Upon receiving content such as a title for the form via the page editor 48 (FIG. 1), the feedback form setup function 34f′ automatically formats the content as feedback form 36f to enable a web site visitor to submit an inquiry to a predetermined feedback recipient. As already noted, the feedback manager 76 is used to setup feedback recipients 78 by enabling the user to input information such as recipient name and recipient email address. In the illustrated example, employment applications are stored in the database 32 (FIG. 1), and are not sent to a particular email address. Accordingly, feedback recipients 78 are not needed for employment application 36e′.

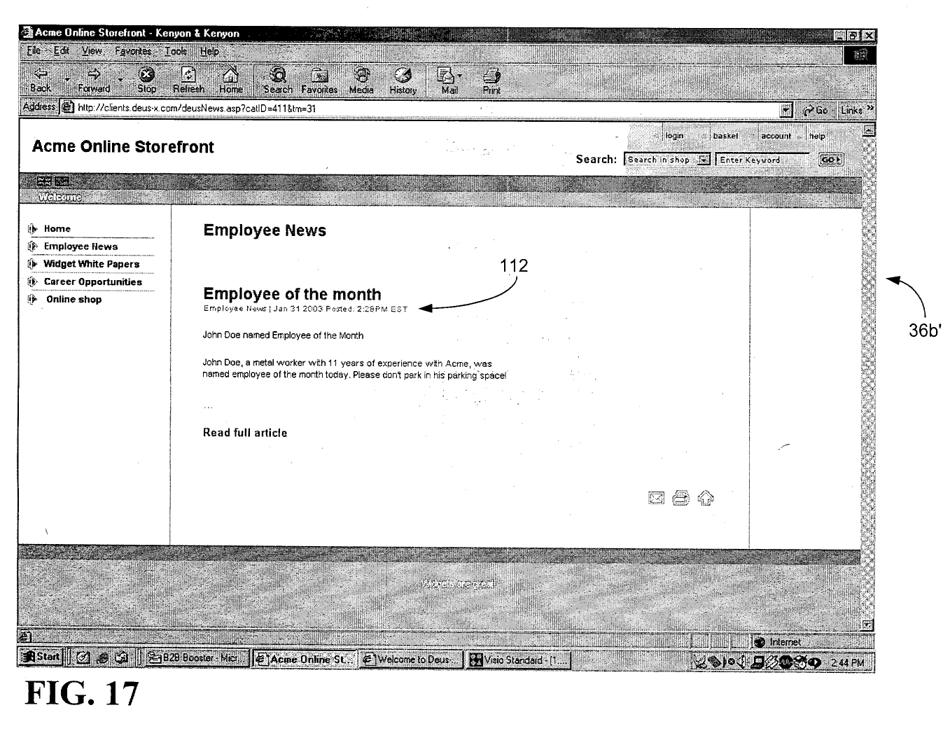

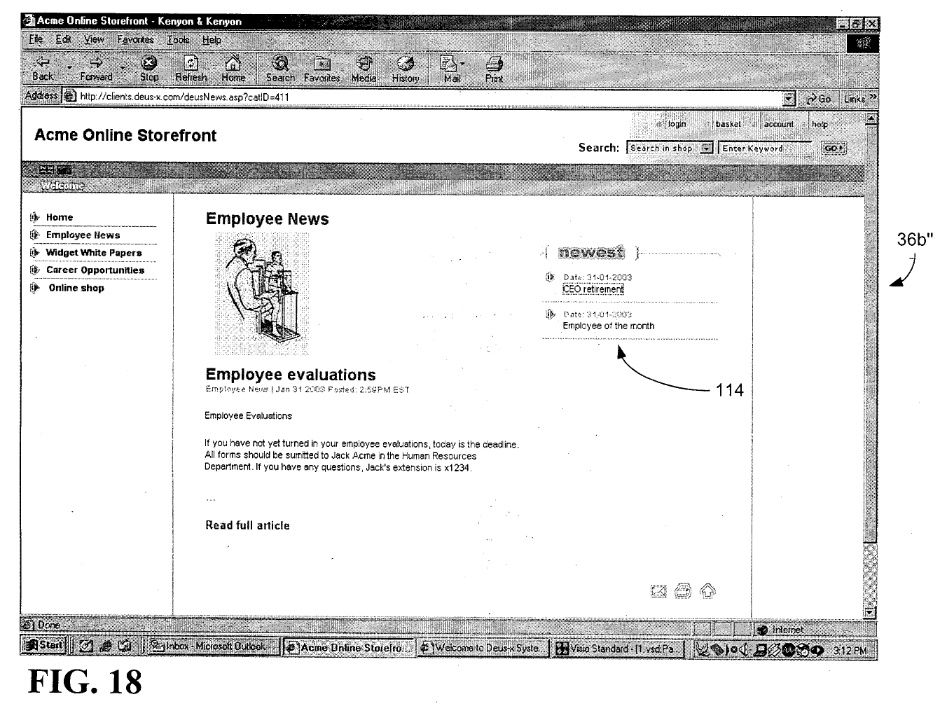

FIG. 5B shows a news setup function 34b′, which arranges news headlines on a headline page 36b′ as a function of the time at which each news headline was created. Specifically, the page categorization input causes the news setup function 34b′ to create a folder that is dedicated to news web pages. Upon receiving content such as a news headline and story via the page editor 48 (FIG. 1), the news setup function 34b′ automatically creates and assigns a time stamp to a full story web page (not shown). The news setup function 34b′ also creates a headline page 36b′ and positions information from the full story web page on the headline page based on the time stamp. Thus, the news pages are divided into two parts: 1) a news headline page, which can display multiple headlines, and 2) a full story page, which is displayed once a headline has been selected. FIG. 17 shows a headline page 36b having information from a news web page. The headline page 36b′ results from the page categorization input, and the news web page results from application of a front page setup function to news content. It can be seen that a time stamp 112 is automatically added to the news web page, where the time stamp indicates the time at which the particular headline was created. FIG. 18 shows a headline web page 36″ in which information from the most recently created headline is displayed more predominately than older headlines 114.

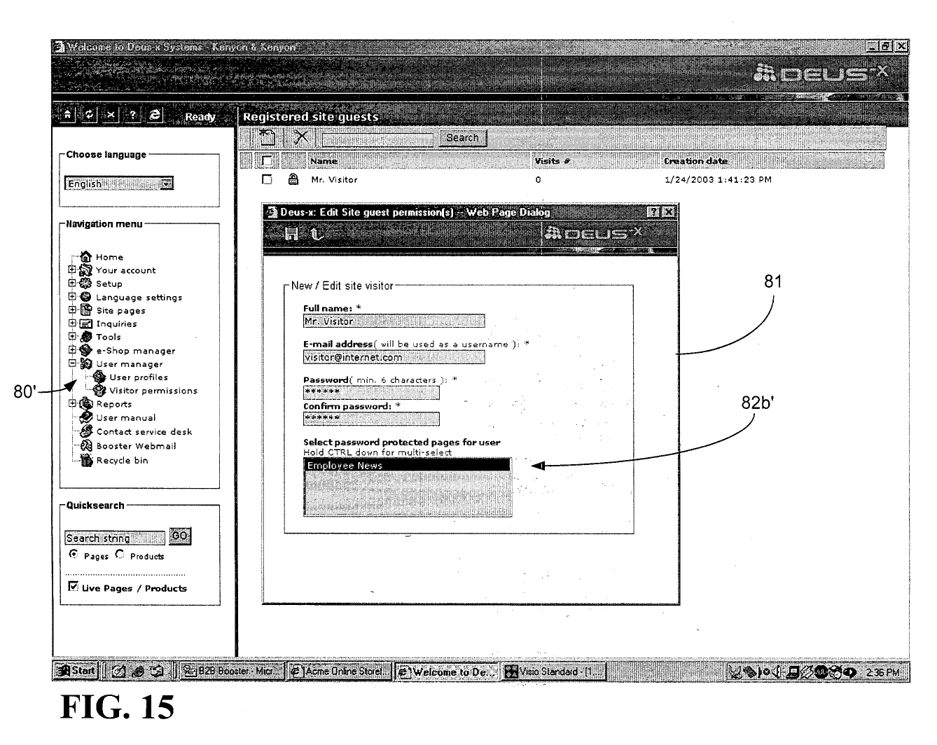

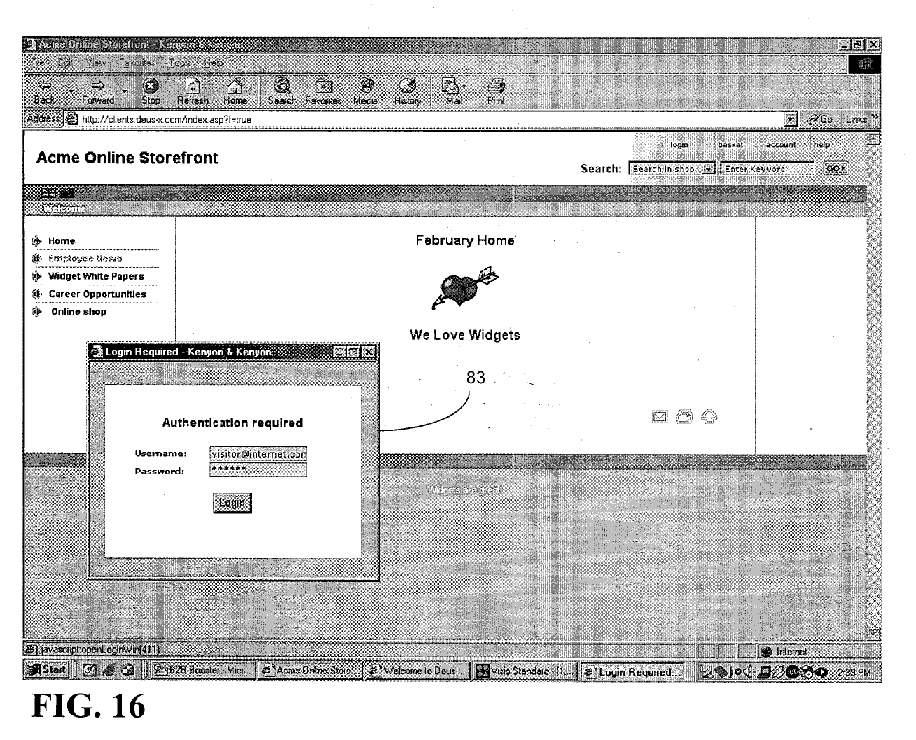

FIG. 5C shows a password protection setup function 42g′ that includes an access manager 80, where the access manager 80 defines privileges 82a for users accessing the back end of the web site management system as well as visitor privileges 84b for visitors accessing the web site. For example, FIG. 15 shows an access manager 80′ having a visitor setup interface 81 that permits a user to define visitor privileges 82b′ by selecting the categories for which visitor authentication is required. FIG. 16 shows an authentication interface 83 that is presented to the visitor when the visitor attempts to access the pre-selected category of web pages (e.g., “employee news”).

Returning to FIG. 1, the illustrated management system 30 also has a language manager 62, where the language manager 62 has a plurality of pre-installed languages and creates an independent web site for each pre-installed language based on language selection input 63. The pre-installed languages may require different character sets.

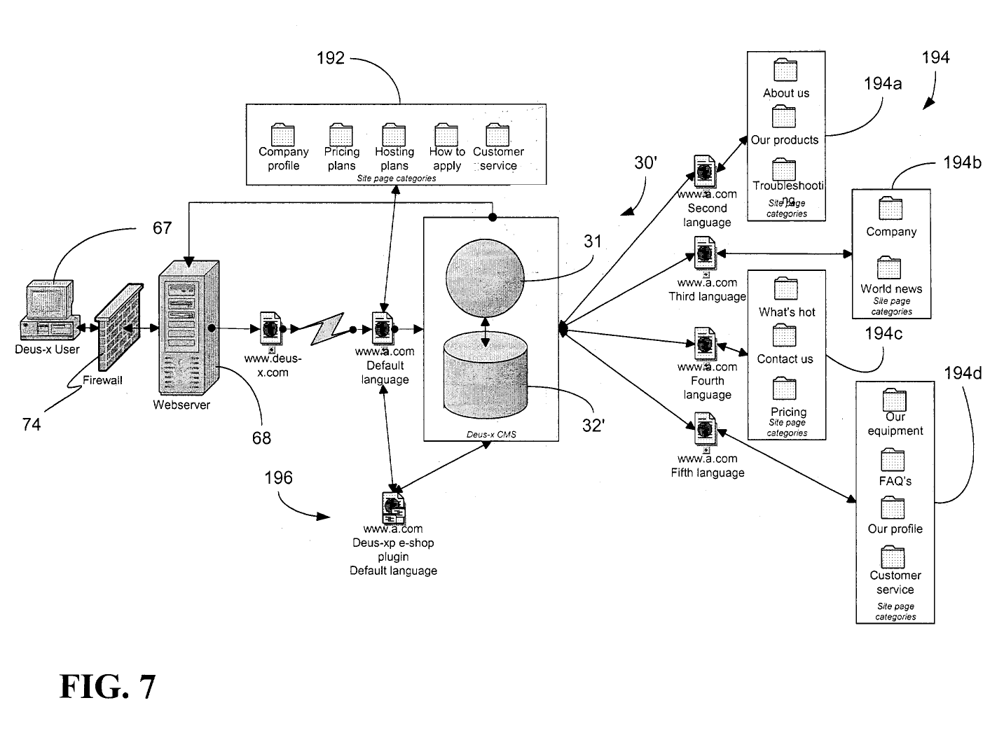

FIG. 7 illustrates the language management capabilities of web management system 30′ in greater detail. Specifically, the domain name associated with the web site account in question (e.g., “www.a.com”) has a default language that is used to create default site page categories 192. Alternative languages can be used to create alternative site page categories 194 (194a-d). As a result, viewers can encounter an entirely different web site depending on the language selected by the user. It should be noted, however, that the illustrated example uses an e-shopping plug-in 196 that posts the data in the default language.

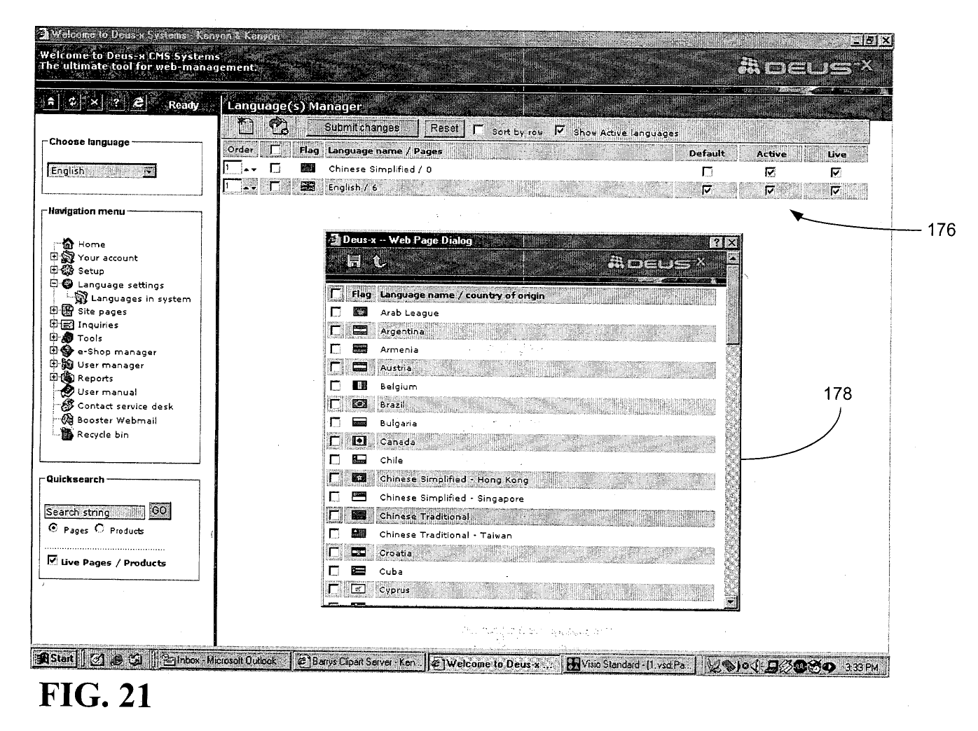

With specific reference to FIG. 21, one approach to a language manager interface 176 is shown. A plurality of pre-installed languages can be selected from language selection interface 178, wherein the languages can include different character sets. For example, the illustrated language manager interface 176 lists “English” and “Chinese Simplified” as the languages that have been selected. The language manager interface 175 supports the language manager 62 (FIG. 1) in enabling the user to create an independent web site for each pre-installed language.

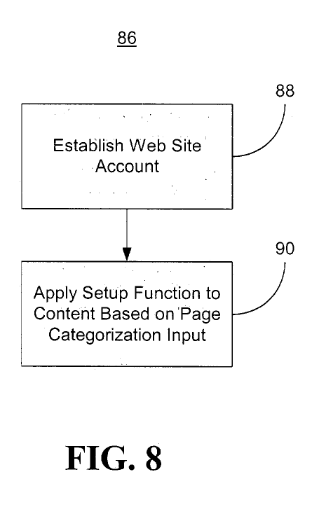

Turning now to FIG. 8, a method 86 of managing a web site is shown. Method 86 can be implemented using a wide variety of hardware and/or software techniques. For example, method 86 can be implemented in a machine readable medium such as a read only memory (ROM), compact disc ROM (CD-ROM), magnetic disc, random access memory (RAM), etc., storing a set of instructions capable of being executed by a processor to manage a web site. Specifically, processing block 88 provides for establishing a web site account corresponding to a domain name. A setup function is applied to content associated with the web site at block 90 based on page categorization input from a web browser.

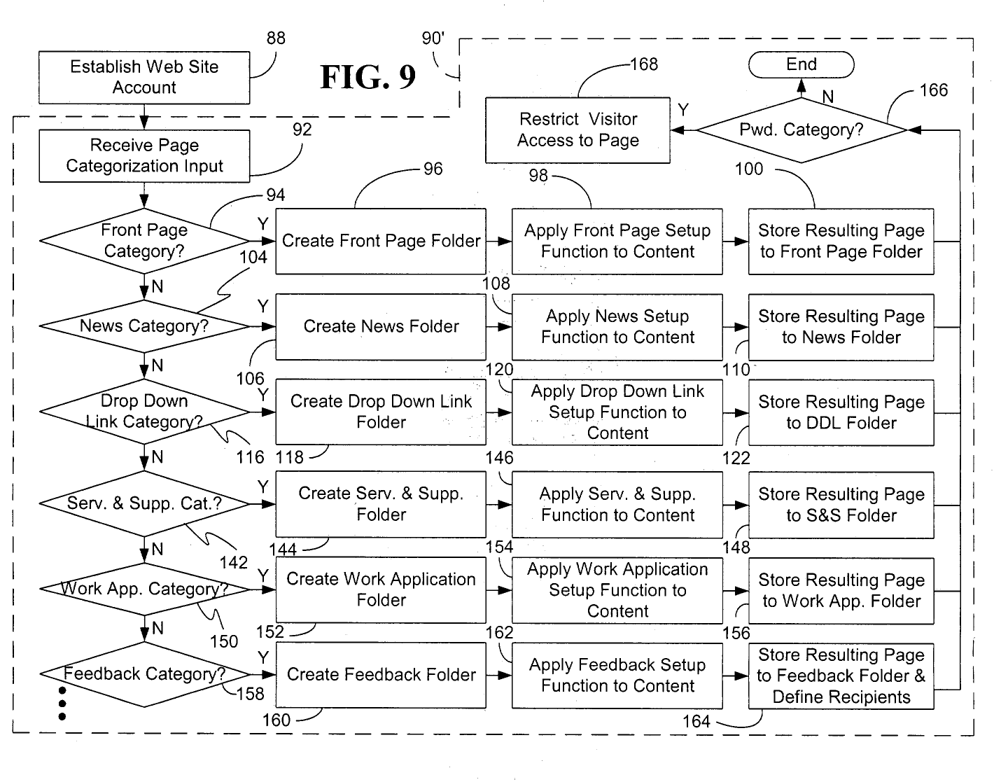

FIG. 9 shows one approach to applying setup functions to content in greater detail at block 90′. Specifically, page categorization input is received at block 92 and a determination is made at block 94 as to whether the page categorization input defines a front page category. If so, a database front page folder is created at block 96 in response to the page categorization input. Block 98 provides for applying a front page setup function to the content and block 100 provides for storing the content as a web page in the front page folder. The front page setup function automatically defines the web page as an index page of the web site account. It should be noted that additional pages can be stored in the front page folder, where one of the web pages is selected as the index page based on page status input from the web browser.

Processing block 104 provides for determining whether the page categorization input defines a news category. If so, a database news folder is created in response to the page categorization input at block 106 and a news setup function is applied to the content at block 108. The content is stored as a web page in the news folder at block 110, where the news function automatically positions news items on the web page as a function of head line creation time.

Block 116 provides for determining whether the page categorization input defines a drop down link category. If so, a database drop down link folder is created in response to the page categorization input at block 118. Block 120 provides for applying a drop down link setup function to the content in question and block 122 provides for storing the content as multiple top level web pages in the drop down link folder. In this regard, it should be noted that folders not created by the drop down link setup function only have a single active top level page at a time. Thus, the drop down link setup function provides the opportunity to further enhance visitor navigation of the web site. Specifically, a link to each top level web page in the drop down link folder is displayed in the navigation menu when the visitor selects the drop down link folder from the index page. It should be noted that the name given to the drop down link folder can be whatever the user desires, but is usually descriptive of the web pages that it holds. For example, if the drop down link folder is going to hold top pages such “company location,” “management team,” and “main products,” the folder may be given the name “the company”. In addition, each top level web page in the drop down link folder can link to multiple sub-pages, regardless of whether the drop down link setup function was selected.

Block 142 provides for determining whether the page categorization input defines a servicing and support category. If so, a database servicing and support page folder is created in response to the page categorization input at block 144. Block 146 provides applying a servicing and support page setup function to the content in question and block 148 provides for storing the content as a web page in the servicing and support folder. In one embodiment, the servicing and support page setup function automatically adds a “help” link for the web page to the index page of web site account.

Block 150 provides for determining whether the page categorization input defines a work application form category. If so, a work application form folder is created in response to the page categorization input at block 152. Block 154 provides for applying a work application form setup function to the content in question and block 156 provides for storing the content as a web page in the work application form folder. The work application form setup function automatically formats the web page to enable a web site visitor to apply employment and submit a resume.

Block 158 provides for determining whether the page categorization input defines a feedback form category. If so, a database feedback form folder is created in response to the page categorization input at block 160. Block 162 provides for applying a feedback form setup function to the content in question and block 164 provides for storing the content as a web page in the feedback form folder. The feedback form setup function automatically formats the web page to enable a web site visitor to submit an inquiry to a predetermined feedback recipient. Block 164 therefore also provides for defining the feedback recipient based on user input. Additional categories, forms and page types can be added to the framework illustrated in method 90′ without parting from the spirit and scope of the embodiments of the invention.

Block 166 provides for determining whether the page categorization input further defines a password protected category. If so, visitors of the web site are prevented from accessing the content at block 168, unless valid authentication data is received.

Product Data Management

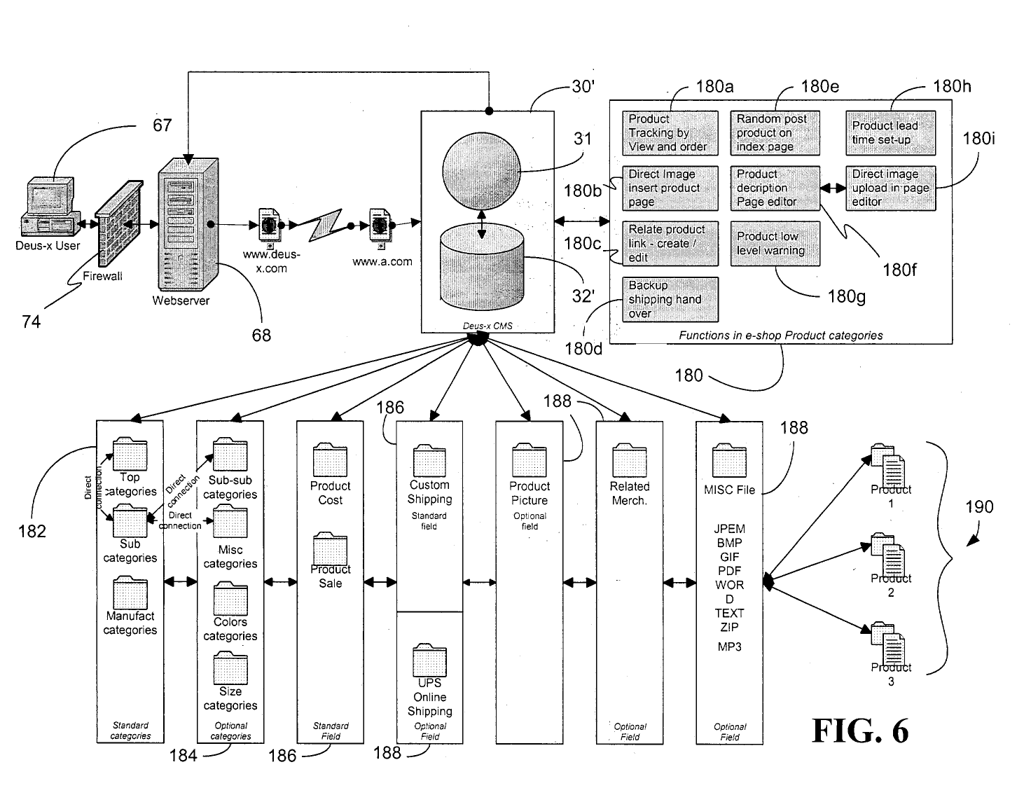

Turning now to FIG. 6, the e-shopping management capabilities of web site management system 30′ are shown in greater detail. Specifically, the e-shopping manager 50 (FIG. 1) can include a plurality of product data functions 180 (180a-i) to assist the user in creating, organizing and viewing the product data. For example, tracking function 180a tracks products as a function of viewing frequency and ordering volume. Thus, the user can determine which products are being viewed the most and ordered the most by visitors of the electronic storefront. Image insert function 180b inserts an image of each product into the web page associated with the product. Product linking function 180c creates and edits links between related products so that when a visitor of the electronic storefront views one product, all related products are also displayed on the page. Shipping handover function 180d provides for automated changes in shipping carriers in the event of shipping backups or communication problems. For example, if the server for “Carrier X” does not respond, custom shipping can be implemented as an alternative.

Random display function 180e randomly posts products on the index page in order to increase visitor interest. Page editor function 180f enables the user to enter a description of each product and collaborates with image upload function 180i to facilitate the uploading of images. Warning function 180g alerts the user to inventory levels that fall below a predetermined threshold. Lead time function 180h enables the user to setup product lead times based on inventory levels. For example, the user can be given the option to select between “On Order”, “Discontinued”, and “Pre/Special Order”, where the selected option is displayed to visitors as the availability of the product in question.

With specific regard to warning function 180g and lead time function 180h, the user is given the opportunity to input a value into a “quantity on hand” field, which represents the quantity of the item in question that the user has in stock, or wishes to sell online. The user is also given the opportunity to input a value into a “low level” field, which represents the predetermined threshold. Until the quantity on hand reaches the low level, visitors of the electronic storefront will see “In stock” as the availability of the item. Once the low level is reached, visitors will see whatever has been selected as the lead time option (e.g., On Order, Discontinued, Pre/Special Order). For example, if the user selects “Pre/Special Order”, and inputs the value twenty for quantity on hand and two for low level, for the next eighteen sold visitors will be given the message “In stock”. After the eighteenth item is sold, “Pre/Special Order” will be displayed. Alternatively, if the user has selected “Discontinue”, the item will automatically disappear from the storefront when the low level is reached. Thus, the quantity on hand automatically reduces as visitors place orders, and the lead time function 180h automatically displays the appropriate message when the low level is reached. In most scenarios, however, users would select the “On Order” option for lead time.

Web site management system 30′ also uses product categorization input 54 (FIG. 1) to define standard categories 182 and optional categories 184. The product data is entered via standard fields 186 and optional fields 188. Within these confines, products 190 can be defined and organized in a logical and hierarchical manner.

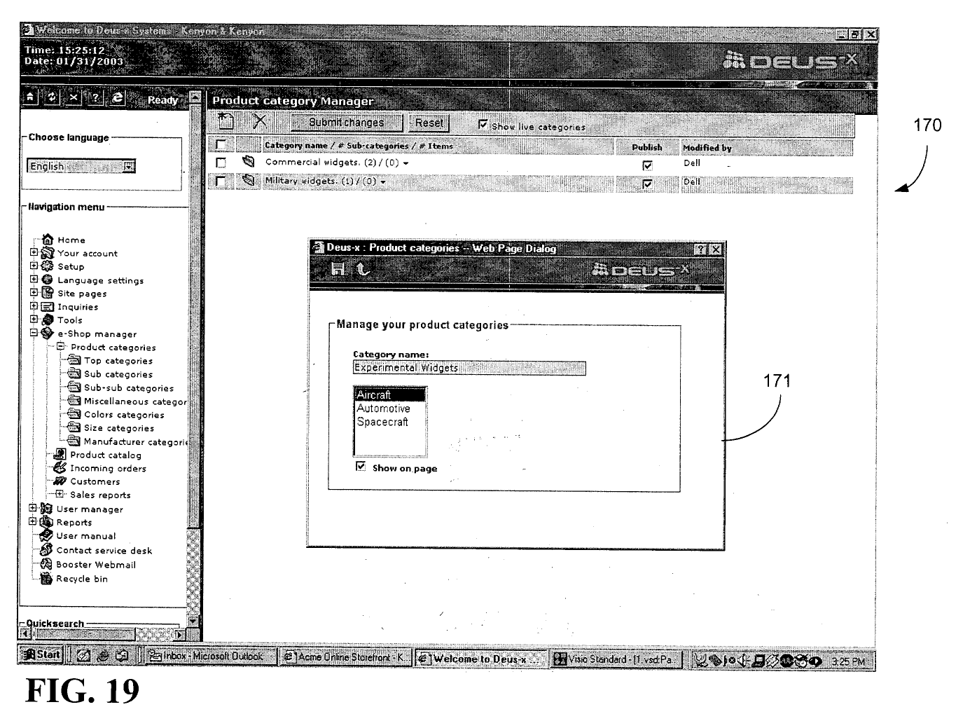

With continuing reference to FIGS. 2 and 19-20, it can be seen that one approach to a product manager 58 uses a product category management interface 170 to enable a user to create categories for the product data. For example, the illustrated electronic storefront has the top categories of “Commercial widgets” and “Military widgets”, and the subcategories “Aircraft,” “Automotive” and “Spacecraft”. The category entry interface 171 further includes the top category of “Experimental widgets,” which is being directly associated with subcategory “Aircraft.” The side navigation menu demonstrates that a wide variety of product categories such as top, sub, sub-sub, miscellaneous, colors, size and manufacturer categories are available. This list is not exhaustive and is only illustrative of the types of categories that can be provided.

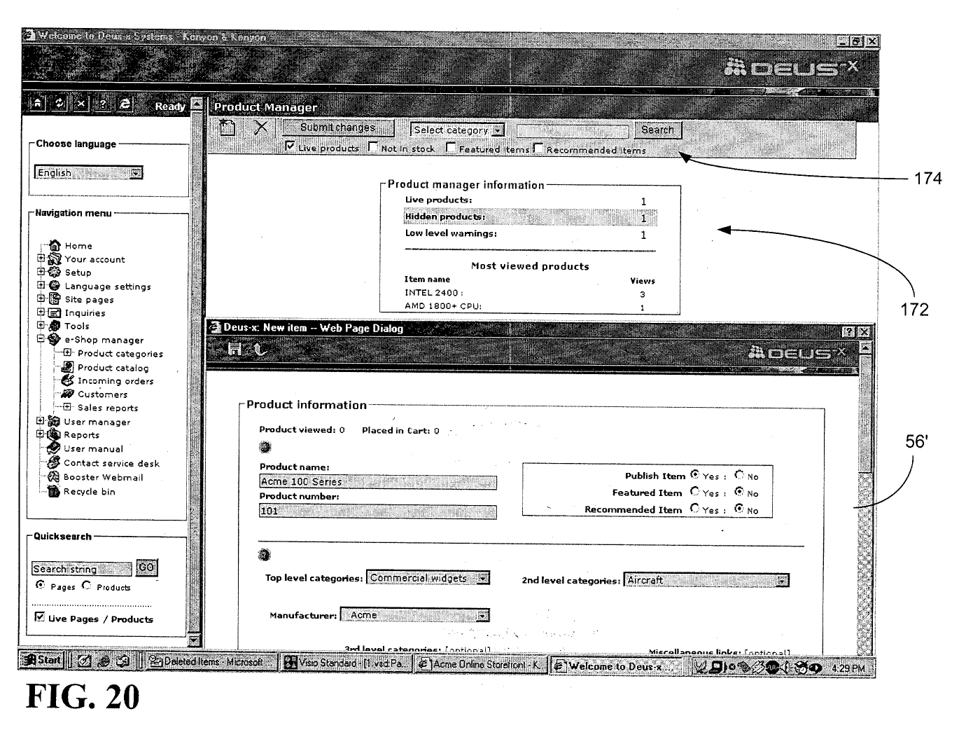

With specific reference to FIGS. 2 and 20, a further approach to an e-shopping manager 50′ (FIG. 2) is shown in which a product manager information display 172 provides pertinent information about the product data, and back end search engine interface 174 enables the user to search the product data. Furthermore, a product editor 56′ enables the user to organize the product data into the aforementioned product categories. For example, the illustrated product 190 (FIG. 6) is given the name “Acme 100 Series,” and is associated with the top-level category of “Commercial widgets,” sub-level category of “Aircraft” and manufacturer category “Acme”.

The above-described components, functions, systems and methods can be implemented using a wide variety of commercially available tools. The following tables include an example of some of the script languages, software, third party components and platforms that can be used. These examples are non-exhaustive, and merely provide a more complete framework for understanding the embodiments of the present invention.

TABLE I
Script Languages

Jscript
SQL
C#
VB Script
CGI
Perl
ASP
ASPX
HTML
COM
XML
CSS
DHTML

TABLE II
Software

Visual Studio.net
Visual Interdev
MS Frontpage
Notepad
Adobe Photoshop

TABLE III
Third Party Components

| | |
|---|---|
| imail postoffice | Mailserver |
| ASP Mail | Webserver |
| ASP Qmail | Webserver |
| Shotgraph | Webserver |
| Dundas Charts.net | Webserver |
| SA Fileup | Webserver |
| SkipJacket Transaction API | Webserver |
| OpenSRS client | Webserver |
| Calendar Control | Webserver |
| Killer Web Templates | Mailserver |
| EZSignup | Mailserver |
| Double-Take Replication Software | Webserver |

TABLE IV
Platform

Windows 2000 Internet Information Server 5
Microsoft SQL Server 2000

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

What is claimed is:

1. A method of managing a web site comprising:
establishing a web site account corresponding to a domain name; and
applying a setup function to content associated with the web site account based on page categorization input from a web browser.

2. The method of claim 1 further including:
creating a database front page folder in response to the page categorization input;
applying a front page setup function to the content; and
storing the content as a web page in the front page folder, the front page setup function automatically defining the web page as an index page of the web site account.

3. The method of claim 2 wherein a plurality of web pages are stored in the front page folder, the method further including selecting one of the plurality of web pages as the index page based on page status input from the web browser.

4. The method of claim 1 further including:
creating a database news folder in response to the page categorization input;
applying a news setup function to the content; and
storing the content as a web page in the news folder, the news setup function automatically assigning a time stamp to the web page, creating a headline page and positioning information from the web page on the headline page based on the time stamp.

5. The method of claim 1 further including:
creating a database drop down link folder in response to the page categorization input;
applying a drop down link setup function to the content; and
storing the content as multiple top level web pages in the drop down link folder.

6. The method of claim 1 further including:
creating a database servicing and support page folder in response to the page categorization input;
applying a servicing and support page setup function to the content; and
storing the content as a web page in the servicing and support page folder, the servicing and support page setup function automatically adding a link for the web page to an index page of the web site account.

7. The method of claim 1 further including:
creating a database work application form folder in response to the page categorization input;
applying a work application form setup function to the content; and
storing the content as a web page in the work application form folder, the work application form setup function automatically formatting the web page to enable a web site visitor to apply for employment and submit a resume.

8. The method of claim 1 further including:
creating a database feedback form folder in response to the page categorization input;
applying a feedback form setup function to the content; and
storing the content as a web page in the feedback form folder, the feedback form setup function automatically formatting the web page to enable a web site visitor to submit an inquiry to a predetermined feedback recipient.

9. The method of claim 8 further including defining the feedback recipient based on user input.

10. The method of claim 1, wherein the page categorization input indicates that the content is to be password protected, the method further including preventing visitors of the web site from accessing the content unless valid authentication data is received.

11. The method of claim 10, further including defining the valid authentication data based on user input.

12. The method of claim 1 further including receiving the content from the web browser via a page editor.

13. The method of claim 1 further including applying a plurality of setup functions to the content.

14. The method of claim 1 further including:
establishing a plurality of web site accounts corresponding to a plurality of domain names; and
applying the setup function to content associated with the plurality of web site accounts.

15. The method of claim 1 further including organizing product data associated with the web site account into one or more product categories based on product categorization input from the web browser.

16. The method of claim 15 wherein the product categories include top, sub, sub-sub, miscellaneous, colors, size and manufacturer categories.

17. The method of claim 15 further including conducting a back end search of the product data based on user search input.

18. The method of claim 1 further including managing an independent web site for each of a plurality of languages requiring different character sets, each independent web site being associated with the web site account.

19. A web site management system comprising:
a database to store a web page associated with a web site account; and
a setup function to automatically format the web page based on page categorization input from a web browser.

20. The web site management system of claim 19, further including an electronic shopping manager to organize product data in the database based on one or more product categories.

21. The web site management system of claim 20, further including a product editor, the product editor to enable a user to enter and selectively associate the product data with one or more of the product categories.

22. The web site management system of claim 20, further including a product manager, the product manager to enable a user to organize the product data into the product categories.

23. The web site management system of claim 22, further including a back end search engine, the back end search engine to enable the user to search the product data.

24. The web site management system of claim 20, wherein the product categories include top, sub, sub-sub, miscellaneous, colors, size and manufacturer categories.

25. The web site management system of claim 19, wherein the setup function automatically formats web pages for a plurality of domain names.

26. The web site management system of claim 19, further including a page editor, the page editor to enable a user identify content for the web page by browsing a computer drive and selecting drive paths.

27. The web site management system of claim 26, wherein the page editor enables the user to select drive paths to images.

28. The web site management system of claim 19, further including a plurality of setup functions, each setup function being configured to create a folder that is dedicated to a particular type of web page.

29. The web site management system of claim 28, wherein the plurality of setup functions include a front page setup function, a news setup function, a drop down link setup function, a service and support page setup function, a work application form setup function, a feedback form setup function and a password protection setup function.

30. The web site management system of claim 29, wherein the news setup function assigns a time stamp to the web page and positions information from the web page on a headline page based on the time stamp.

31. The web site management system of claim 29, wherein the password protection function includes an access manager, the access manager to define privileges for users accessing a back end of the web site management system and visitors accessing the web site.

32. The web site management system of claim 29, further including an inquiry manager, the inquiry manager to enable a user to setup feedback recipients and view submitted inquiries.

33. The web site management system of claim 32, wherein the inquiry manager further enables the user to view submitted resumes.

34. The web site management system of claim 19, further including a page categories manager, the page categories manager to enable a user to view folders created in response to the page categorization input.

35. The web site management system of claim 19, further including a language manager, the language manager having a plurality of pre-installed languages to enable a user to create an independent web site for each pre-installed language.

36. A web site management system comprising:
a database to store web pages associated with a web site account;
a plurality of setup functions to automatically format the web pages based on page categorization input from a web browser, each category setup function being configured to create a folder that is dedicated to a particular type of web page;
an electronic shopping manager to organize product data in the database based on one or more product categories;
a page editor, the page editor to enable a user to create the web pages by browsing a computer drive and selecting drive paths to images;
a page categories manager, the page categories manager to enable the user to view folders created in response to the page categorization input; and
a language manager, the language manager having a plurality of pre-installed languages to enable a user to create an independent web site for each pre-installed language.

37. The web site management system of claim 36, further including a product editor, the product editor to enable a user to enter and selectively associate the product data with one or more of the product categories.

38. The web site management system of claim 36, further including a product manager, the product manager to enable a user to organize the product data into the product categories.

39. The web site management system of claim 38, further including a back end search engine, the back end search engine to enable the user to search the product data.

40. The web site management system of claim 36, wherein the plurality of setup functions automatically format web pages for a plurality of domain names.

41. A machine readable medium comprising a stored set of instructions capable of being executed by a processor to:
establish a web site account corresponding to a domain name; and
apply a setup function to content associated with the web site account based on page categorization input from a web browser.

42. The medium of claim 41, wherein the instructions are further capable of being executed to:
create a database front page folder in response to the page categorization input;
apply a front page setup function to the content; and
store the content as a web page in the front page folder, the front page setup function automatically defining the web page as an index page of the web site account.

43. The medium of claim 41, wherein the instructions are further capable of being executed to:
create a database news folder in response to the page categorization input;
apply a news setup function to the content; and
store the content as a web page in the news folder, the news setup function automatically assigning a time stamp to the web page, creating a headline page and positioning information from the web page on the headline page based on the time stamp.

44. The medium of claim 41, wherein the instructions are further capable of being executed to:
create a database drop down link folder in response to the page categorization input;
apply a drop down link setup function to the content; and
store the content as multiple top level web pages in the drop down link folder.

45. The medium of claim 41, wherein the instructions are further capable of being executed to:
establish a plurality of web site accounts corresponding to a plurality of domain names; and
apply the setup function to content associated with the plurality of web site accounts.

46. The medium of claim 41, wherein the instructions are further capable of being executed to organize product data associated with the web site account into one or more product categories based on product categorization input from the web browser.

47. The medium of claim 46, wherein the instructions are further capable of being executed to conduct a back end search of the product data based on user search input.

48. The medium of claim 41, wherein the instructions are further capable of being executed to manage an independent web site for each of a plurality of languages requiring different character sets, each independent web site being associated with the web site account.
